(19) United States
(12) Patent Application Publication
(10) Pub. No.: US 2002/0159606 A1
(43) Pub. Date: Oct. 31, 2002

(54) Electrodynamic transducer with acceleration control

(76) Inventor: Maximilian Hobelsberger, Wuerenlingen (CH)

Correspondence Address: MAX HOBELSBERGER, DORFSTR. 16, WVERENLINGEN, CH-5303, CH

(21) Appl. No.: 09/844,870

(22) Filed: Apr. 30, 2001

(51) Int. Cl. H04R 3/00

(52) U.S. Cl. 381/96

(57) ABSTRACT

The transducer is equipped with motion sensors for measuring the motion of its membrane and current sensors for measuring the current through the voice coil. The signals generated by the motion sensors are used for the control of low-frequency spectral components and the signals generated by the current sensors are used for control of the high-frequency spectral components of the membrane's motion.

### BACKGROUND OF THE INVENTION

1. Field of the Invention

The present invention relates generally to electrodynamic transducers. More particularly it relates to electrodynamic loudspeakers with closed-loop control systems for the control the membrane's motion (called “motional feedback systems”).

2. Description of Related Art

In some systems which are employed for e.g. sound reproduction electrodynamic transducers are used together with control devices or circuits which control the motion (for example position, speed, acceleration) of the transducer's membrane. For this the motion of the membrane is measured by motion sensors, e.g. piezoelectric sensors. The signals generated by the sensors are forwarded to closed loop control circuits which control the motion of the membrane of the electromechanic transducers.

However at higher frequencies usually the motion sensors measure not only the true motion of the membrane, but also all kinds of disturbing, “noise” motions, which are caused by resonance effects of the mebrane and the whole system. So it is difficult and expensive to achieve a correct control of the true motion of the mebrane at higher frequencies. But even a control at lower frequencies requires a correct measurement of the membrane's motion at higher frequencies because of control dynamics. So the measurement of higher frequency components is desirable.

For example in the U.S. Pat. No. 4,573,189 a special arrangement of an acceleration sensor within the voice-coil of the transducer is described. It seems that this special placement would increase the cost of the transducer considerably.

Another U.S. Pat. No. 5, 764, 781 describes a control system which utilizes both motion information and current information to control the motion. However the measured values are used differently and in a very specific way in this present invention.

### SUMMARY OF THE INVENTION

The invention circumvents the above mentioned difficulties concerning the correct measurement of the motion and enables a correct motion control over a wide frequency range at lower cost.

According to the invention the motion of the mebrane of the electrodynamic transducer (e.g. a loudspeaker) is measured by at least one motion sensor, and additionally by measurement of the electrical current which flows through the driving coil of the electrodynamic transducer. The closed-loop controller uses both the signals from the motion sensors and from the current sensors to gain information about the motion. The controller uses the signals from the motion sensors for control of lower-frequency motion and the signals from the current sensors for control of higher-frequency motion.

For a fuller understanding of the nature of the invention, reference should be made to the following detailed description of the preferred embodiments of the invention, considered together with the accompanying drawings.

### BRIEF DESCRIPTION OF THE DRAWINGS

FIG. 1 is a general functional view of the preferred embodiment.

FIG. 2 is a more detailed view of a system that is a preferred embodiment of the present invention.

### DESCRIPTION OF THE PREFERRED EMBODIMENT

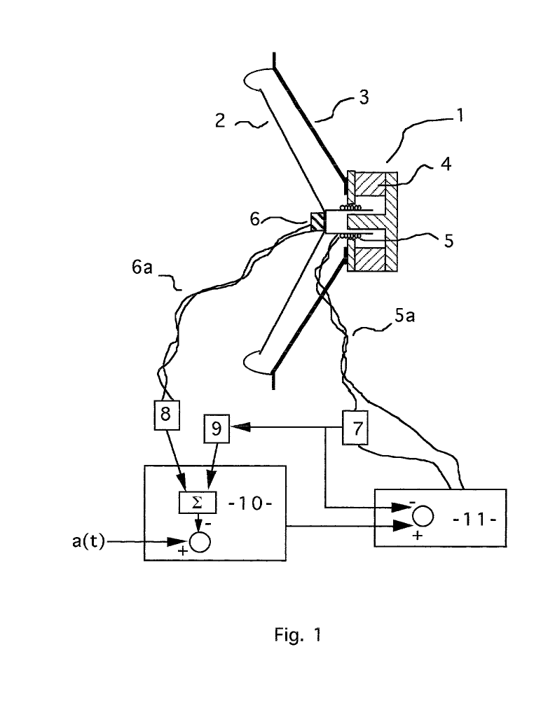

The following is a description of the preferred embodiment of the invention and refers to FIG. 1. The actual parameters of this embodiment serve just as example values and must be varied in accordance to the actual components used.

The preferred embodiment comprises a electrodynamic transducer of the voice-coil type with a motional feedback closed-loop control system for control of the motion of the transducer's membrane. In the preferred embodiment this electrodynamic transducer is a conventional and well known electrodynamic loudspeaker 1, basically comprising a membrane 2, a basket 3, a magnet system 4 and a voice-coil 5 connected to the membrane and inserted into the gap of the magnet system. Electrical current flowing through the voice-coil will cause it to move and displace the mebrane.

The invented system comprises in addition motion sensing means 6, current sensing means 7, first filtering means 8, second filtering means 9, control means 10 and amplifying means 11.

Motion sensing means 7 is in the preferred embodiment a micromachined accelerometer with a good sensivity at low frequencies. However all kinds of other motional sensors may be used as motion sensing means for measuring the motion, e.g. piezo-accelerometers, seismic accelerometers, inductive speed pick-ups, capacitive or inductive or optical (e.g. laser) sensors for position measurement, just to name a few.

The motion sensing means measure the motion and produce signals indicative of the motion, called “motion signals”. These motion signals are conveyed via wires 7a to first filtering means 8 for filtering. Accordingly in the preferred embodiment the signal indicative of the acceleration in conveyed to the filter 8.

These first filtering means 8 are lowpass filters. or bandpass filters with substantially low-pass characteristics in comparison with the high-pass characteristics of the second filtering means.

In the preferred embodiment this first filtering means is a filter with substantially first order transfer characteristic (i.e. transfer function with first order slope) at and arround the corner frequency at the upper end of its passband. The main function of the first filtering means is to block the transfer of higher-frequency components and to transfer only lower-frequency signal components to the controller. In general other types of filters may be used too for low-pass filtering, e.g. other filter topologies like band-pass filters and filters of higher order, and combinations with other components, e.g. inductances, switched capacitor filters, or digital filters. (In fact in technical reality any filter has a transfer function of higher order.)

More specifically, first filtering means is in the preferred embodiment a R-C (resitor-capacitor) low-pass filter of substantially first order, which lowpass-filters the signal conveyed to it from the accelerator.

The invented system further comprises current sensing means 7 for measuring the electrical current flowing through the voice-coil 5 and the wires 5a. In the preferred embodiment a series resistor is used as current sensing means.

In general any other type of current sensor may be used as well, e.g. Hall sensors or other magnetic or inductive sensors.

The signals produced by the current sensing means 7, called the “current signals”, are conveyed to filters 9, called “second filtering means”. Second filtering means 9 is in the preferred embodiment a R-C-type high-pass filter of predominantly first order, which high-pass-filters the signal conveyed to it in the well known manner: It transfers higher-frequeny signal components and blocks lower frequency components.

In the preferred embodiment this second filtering means is a filter with substantially first order transfer characteristic at and arround the corner frequency at the lower end of its passband.

In general other types of high-pass filters may be used as second filtering means, e.g. other filter topologies like bandpass filters and filters of higher order, and combinations of other components, e.g. inductances, or switched capacitor filters, or digital filters.

The output signals produced by the second filtering means, called “filtered current signals”, are then conveyed to the control means 10.

In the preferred embodiment the corner frequency at the upper end of the passband of the first filtering means (lowpass filter) and the corner frequency at the lower end of the passband of the second filtering means (highpass filter) coincide, i.e. are substantially equal.

Control means 10 is in the preferred embodiment a PDT₁-controller with adequately adjusted control parameters. Other controllers with other topologies (e.g. P or PID controllers; state-space controllers; multi-loop, multi-variable controllers, controllers with several inputs and outputs, or feedforward controllers with adaptive algorithms) may be used as control means as well. In general the control means evaluates the relation between the received setpoint signals indicative of the desired “setpoint” motion of the membrane and the received signals indicating the actual motion (motion signals) and drives via amplifying means 11, e.g. a power amplifier, the voice-coil to eliminate the differences between desired “setpoint” motion and the measured actual motion. “Drives” means that the amplifier causes electrical current to flow through the voice coil 5 (or sometimes several voice coils) connected to the output of the amplifier by wires 5a.

So in the preferred embodiment the PDT1-controller's output is connected to the input of the amplifier 11. The amplifier's 11 output is connected to the voice-coil 5.

The above described control mechanisms are all conventional control technique and well known in the art.

In the preferred, example embodiment the first filtering means and the second filtering means (i.e. the low-pass filter and the high-pass filter) have both substantially the same corner frequency (i.e. pole frequency or −3 dB frequency) at 338 Hz for example. The corner frequency will depend on the transducers and sensors used!

As already stated both filtered signals are conveyed to the controller 10 which evaluates them and uses them to control the motion of the membrane in accordance to a received setpoint signal a(t), which may be an audio signal for example. In the preferred embodiment calculating means are arranged to combine the filtered signals by application of mathematical operations. In the preferred embodiment this calculating means is a summation amplifier which adds the signals.

It is known in the art that by summation of two signals, which were gained by low-pass filtering respectivly high-pass filtering of identical source signals the original source signal can be reconstructed. This is exactly correct in the case that the filters are of first order and have the same corner frequency and amplification. In the Laplace domain this fact is described by the following equation where the transfer functions are added:

K/(1+sT)+K*s/(1+sT)=K.

K is the factor of amplification (or attenuation) and T is the dominant time constant, with 1/(2πT) being the corner frequency of the filters. The above stated relation is approximately true for filters of higher order, if the additional poles of the filters (i.e. their corner frequencies) are sufficiently distant from the main (or “dominant”) first-order frequencies. So in the preferred embodiment the low-pass filtering means is a low-pass filter of predominantly first order, that means that higher pole-frequencies are sufficiently far away from the first “dominant” corner frequency. In the frequency-range of interest the filter behaves like a first order filter. In the preferred embodiment the corner frequency of the low-pass filter is chosen to be at for example 338 Hz. This is sufficiently lower than the 1500 Hz—corner frequency of the accelerometer used in the example.

The current sensing means indicates the membrane's acceleration very well at frequencies sufficiently above the main resonance frequency of the transducer. In the preferred embodiment this main resonance frequency is for example 60 Hz. At higher frequencies (e.g. >200 Hz in the embodiment) the membrane's acceleration is mainly determined by the moving mass of the transducer (mainly the mass of the membrane and the voice coil) and the force acting upon this mass. This force and with it the acceleration is directly and constantly proportional to the current because the strength of the magnetic field of the magnet system is constant. So the current may be used to measure the acceleration at higher frequencies. Accordingly the high-pass filtering means in the first embodiment is a high-pass filter of predominantly first order, that means again that further poles of the transfer function are sufficiently lower than the main pole at the corner frequeny. In the example embodiment this corner frequency is chosen to be 338 Hz. This is the same corner frequency as at the low-pass filter in this example. Of course the chosen frequencies will depend on the used parts (accelerometer, transducer).

So by appropriate amplification of the signals from the accelerometer (or more general from the motion sensing means) and from the current sensor (the current sensing means), by filtering these signals and by addition (in general: by mathematical combination) of these filtered signals a signal can be gained which indicates, or is proportional as in the preferred embodiment, the acceleration with great precision over a wide frequency span.

It should be noted that the amplification, the filtering and the summation or combination can be achieved by analog methods or also digital methods. In other embodiments the controller could process both kind of signals, the motion signals and the current signal, separatedly and combine or use them at a later stage of processing.

So in the preferred embodiment the first filtering means which filter the signal from the motion sensor (accelerometer) is a bandpass filter with substantially first order characteristic at the upper end of its passband, and the second filtering means which filter the current signal is a bandpass filter with substantially first order characteristic at the lower end of its passband. (Simple lowpass and highpass filters are can be considered as special cases of bandpass filters). The corner frequency at the upper end of passband of the first filtering means (motion filter) and the corner frequency at the lower end of passband of said second filtering means (current filter) are substantially the same.

So the basic method of operation of the above decribed arrangement is that the signals from the current sensing means are predominantly used by the controller to control the motion of the mebrane at higher frequencies, or, in other words, to control the spectral higher-frequency components of the motion. Correspondingly the signals from the motion sensing means are predominantly used by the controller to control the spectral lower-frequency components of the membrane's motion. The control is performed by a well known closed-loop controller, together with an amplifier, in accordance to the received setpoint signals for motion. Of course at frequencies close to the corner frequencies of the low-pass and the high-pass filter (these frequencies usually will be chosen to be substantially the same) the controller will use both filtered signals simultaniously and more or less equally to control the motion.

That means that spectral higher-frequency components of the motion signals from the motion sensors, which have a large phase delay, will not influence the controller's output signal. Accordingly spectral lower-frequency components of current signals from the current sensors will not influence the controller's output signal at lower current-signal frequencies.

The control means 10 generates steering signals which are conveyed to the amplifying means 11. This amplifying means drive the voice-coils, i.e. produce the currents through the voice-coils according to the signals produced by the controller. This amplifying means is in the preferred embodiment a controlling current source which generates and controls the current through the one voice-coil according to the steering signal received from the controller as current setpoint signal. It uses the signal from the current sensor as feedback signal describing the actual Current through the coil. A current controller of this kind is well known in the art and needs no further description. The use of a current controller contributes to the stability of the overall system.

However other types of power amplifiers may be used as amplifying means, e.g. amplifiers without current control function or amplifiers which control the voltage at the output to the voice coil. Another possibility is that the current control function or power-amplification function is implemented in the main controller.

Another embodiment employs two completely seperate signal branches, each comprising one voice-coil, one amplifier and one controller. So there are two voice-coils attached to the mebrane, and two controllers and two amplifiers used in the system. The first branch receives the filtered current signals and controls the motion at higher motional frequencies. The other branch receives the filtered motion signals and controls the motion at lower frequencies.

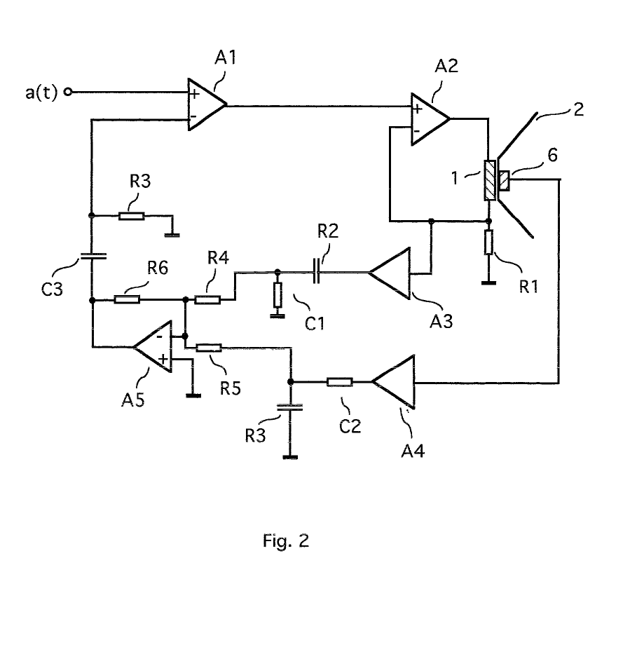

FIG. 2 gives a more detailed view of the preferred embodiment, with certain values as example. A1 is the controller of the PDT1 type (proportional-differential with time delay) which is well known in the art and not shown in further details. The controller receives at its non-inverting input, +, the acceleration signal a(t) as setpoint signal. At its inverting input, −, the controller receives via a high-pass filter (capacitor C3 and resistor R7) a signal indicating the actual acceleration. Capacitor C3 has a value of 470 nF, resistor R7 has a value of 1 MΩ in this example. This filter is used to remove stationary values from the signal. It could be incorporated also in the controller or in other parts of the system. The output signal of the controller A1 is conveyed to the non-inverting input of the current controller A2 which drives and controls the current through the voice-coil of the loudspeaker 1. Controller A2 is again of the PDT1-type. The current signal is produced across a current sensor, which is the resistor R1 with a value of 1 Ω (example). The current signal is fed back to the inverting input of the current controller.A2. Additionally it is conveyed via a buffer amplifier A3 to a high-pass filter with C1 (100 nF,(example)) and R2 (4.7 kΩ, (example)) which gives a corner frequency of 338 Hz (example). The filtered current signal is conveyed from C1 to the resistor R4 (1 MΩ, (example)) of the summation amplifier A5. The acceleration of the membrane 2 of the loudspeaker is measured also by an accelerometer 6. The acceleration signal produced by the accelerator is conveyed via a buffer amplifier A4 to a low-pass filter consisting of C2 (100 nF, (example)) and R3 (4.7 kΩ, (example)). The filtered acceleration signal is conveyed from R3 to the resistor R5 (1 MΩ) of the summation amplifier A5. The summation amplifier A5 further comprisis the feedback-resistor R6 (1 MΩ). The amplification of the buffer amplifiers is chosen to produce a constant voltage/acceleration characteristic, V/g=const., of the signal at the output of the summation amplifier. At a acceleration sensor sensitivity of 2V/g and a current sensor sensitivity of 0.5V/g (stemming from an acceleration characteristic of 2 g/A of the loudspeaker) the buffer A3 has an amplification of −4, and the buffer A4 has an amplification of −1. So in the end the signal at the output of A5 has a sensitivity of 2V/g. All values are given just as example values.

While the present invention has been described in connection with particular embodiments thereof, it will be understood by those skilled in the art that many changes and modifications may be made without departing from the true spirit and scope of the present invention. In particular different control topologies, different types of filters, sensors and amplifiers may be used. Therefore, it is intended by the appended claims to cover all such changes and modifications which come within the true spirit and scope of this invention as given in the above description:

What is claimed is:

1.) An electrodynamic transducer system with a motional feedback closed-loop control system for motion control of the transducers membrane, comprising
a) an electrodynamic transducer comprising a membrane and at least one voice-coil attached to the membrane,
b) motion sensing means for measuring the motion of said membrane and producing motion signals indicative of said motion,
c) current sensing means for measuring the currents flowing through said voice-coils and producing current signals indicative of said currents,
d) control means of the closed-loop type, receiving said motion signals and receiving said current signals, for controlling the motion of said membrane in accordance to at least one received setpoint signal by using said motion signals predominantly to control the spectral lower-frequency components of said membrane's motion and by using said current signals predominatly to control the spectral higher-frequency components of said membrane's motion, and for producing at least one steering signal,
e) amplifying means receiving said steering signals from said control means and for driving electrical currents through said voice-coils in reaction to said steering signals,
whereby by using said current signals and said motion signals said membrane's motion is controlled by said control means over a wide frequency range in accordance to said setpoint signals.

2.) System according to claim 1, further comprising
a) first filtering means receiving said motion signals for lowpass—filtering said motion signals generated by said motion sensing means and producing filtered motion signals, which are conveyed to said controlling means,
b) second filtering means receiving said current signals for highpass—filtering said current signals generated by said current sensing means and producing filtered current signals, which are conveyed to said controlling means,
wherein said control means use said filtered current signals and said filtered motion signals to control the motion of said membrane.

3.) System according to claim 2,
wherein said first filtering means is a filter with substantially first order characteristic at the upper end of its passband,
and wherein said second filtering means is a filter with substantially first order characteristic at the lower end of its passband.

4.) System according to claim 3,
wherein the corner frequency at said upper end of passband of said first filtering means and the corner frequency of said lower end of passband of said second filtering means are substantially the same.

5.) System according to claim 4,
wherein said control means further comprises calculating means for combining the output signals of said filtering means by addition.

6.) System according to claim 2,
wherein said first filtering means is a lowpass filter with a transfer characteristic at its upper end of passband of substantially first order,
and wherein said second filtering means is a highpass filter with a transfer characteristic at its lower end of passband of substantially first order.

7.) System according to claim 6,
wherein the corner frequency of said lowpass filter and the corner frequency of said highpass filter are substantially the same.

8.) System according to claim 7,
wherein said control means further comprises calculating means for combining the output signals of said filtering means by addition.

9.) System according to claim 1,
wherein said amplifying means is a current source for controlling the current through said voice coil according to said steering signals received from the controlling means by using said current signals from the current sensing means.

10.) System according to claim 2,
wherein said amplifying means is a current source for controlling the current through said voice coil according to said steering signals received from the controlling means by using said current signals from the current sensing means.

11.) Method for controlling the motion of the membrane of an electrodynamic transducer, comprising the steps of:
a) measuring the motion of the membrane with motion measuring means and producing motion signals indicative of this motion,
b) measuring the currents through the voice coils of the transducer with current sensing means and producing current signals indicative of said currents,
c) using said motion signals to control the lower-frequency components of the motion of said membrane,
d) using said current signals to control the higher-frequency components of the motion of said membrane,
e) controlling said lower-frequency components and higher-frequency components by a controller.
